(19) United States
(12) Patent Application Publication
(10) Pub. No.: US 2026/0261916 A1
(43) Pub. Date: Sep. 3, 2026

(54) VEHICLE INTERIOR/EXTERIOR SENSING USING CELLULAR RADIO RESOURCES

(71) Applicant: Robert Bosch GmbH, Stuttgart (DE)

(72) Inventors: Vivek JAIN, Sunnyvale, CA (US); Ruofeng LIU, East Lansing, MI (US)

(21) Appl. No.: 19/068,415

(22) Filed: Mar. 3, 2025

(51) Int. Cl. H04W 28/18; H04W 4/02

(52) U.S. Cl. CPC H04W 28/18; H04W 4/02

(57) ABSTRACT

Vehicle interior/exterior sensing using cellular resources is disclosed. A first cellular communications device in a vehicle communications with a cellular station, requesting a plurality of radio resources. The first cellular communications device receives radio resources from the cellular station and allocates a first set thereof for sensing applications and a second set thereof for communications applications. Wireless signals are transmitted and received by the first cellular communications device and processing is carried out by a computing device coupled thereto. The processing includes processing sensor data using the first set of radio resources.

### TECHNICAL FIELD

The present disclosure relates to performing sensing applications within the interior of a vehicle, and more particularly, to using cellular radio resources to perform such sensing.

### BACKGROUND

Interior, in-cabin sensing in vehicles using wireless transmitters and receivers may employ various types of radio technologies. For example, some in-cabin radars utilize ultra-wideband (UWB) radars, which transmit signals over a wide frequency spectrum (e.g., 3.1-10.6 GHz). In in-cabin radar applications, a UWB transmitter may transmit short pulses across the frequency spectrum at timed intervals, and may achieve centimeter-level accuracy with low interference. Other in-cabin and vehicular radars may utilize frequency modulation continuous wave (FMCW) technology in which a transmitter transmits a continuous, frequency-modulated wave. Part of this signal is reflected back to a receiver, after which a frequency shift of the returned signal is measured to determine the distance to the target. Using UWB or FMCW, specialized in-cabin radar systems may be implemented for various applications, such as determining whether or not any occupants are within the cabin.

### SUMMARY

Vehicle interior/exterior sensing using cellular resources is disclosed. A method for utilizing cellular resources to perform in-cabin sensing in a vehicle according to the disclosure includes initiating communications, using a first cellular communications device in a vehicle, with a remote cellular station to request a plurality of radio resources, wherein each of the plurality of radio resources comprises a frequency sub-carrier and a timeslot. The method further includes receiving, from the remote cellular station, the plurality of radio resources, allocating a first subset of the plurality of radio resources for use by one or more sensing applications, and allocating a second subset of the plurality of radio resources for use by one or more communications applications. The method further includes transmitting and receiving wireless signals, using the first cellular communications device and the first and second subsets of radio resources, and processing, using a computing device coupled to a first cellular communications device, sensor data generated based on the transmitting and receiving of the wireless signals of the first subset. Processing the sensor data includes determining, based on the sensor data, a number of occupants in the vehicle.

### BRIEF DESCRIPTION OF THE DRAWINGS

FIG. 1 shows a system 100 for training a neural network.

FIG. 2 shows a computer-implemented method 200 for training a neural network.

FIGS. 3A-3C show various examples of methods for cellular devices to obtain resources from a base station for in-vehicle sensing.

FIGS. 4A-4G illustrate various sensor configurations within a vehicle for systems that perform in-vehicle sensing.

FIGS. 5A-5D illustrate various examples of resource assignment for in-vehicle sensing and communications with a base station.

FIG. 6 shows an example of a method for utilizing cellular resources for in-vehicle sensing.

FIG. 7 depicts a schematic diagram of an interaction between computer-controlled machine 510 and control system 512.

FIG. 8 depicts a schematic diagram of the control system of FIG. 1 configured perform control functions within a vehicle.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

Cellular wireless technology has made significant progression in terms of increasing data throughout, system capacity and reduced latency. Some wireless technologies additionally support distributed large-scale AI models and wireless sensing. Currently wireless sensing for vehicular interior/exterior sensing is enabled using ultra-wideband (UWB) impulse radars or frequency-modulated continuous wave (FMCW) based 60 GHz radars. With the advent of cellular devices being able to support both communication and sensing (e.g., 6G devices), the present disclosure is directed to various methods to enable several applications simultaneously using cellular communications hardware and thereby replacing several individual solutions with cellular network technology.

In various implementations, the present disclosure contemplates one or more wireless devices including respective transmitters/receivers operating within a vehicle and performing both sensing and communications functions. The wireless devices may include at least one dedicated device within the vehicle and/or one or more portable wireless devices (e.g., smart phones) brought into a vehicle with occupants thereof. At least one wireless device within the vehicle contacts a cellular base station to request a plurality of radio resources, wherein the radio resources comprise at least a frequency subcarrier and a timeslot. As used herein, radio resources may alternatively be referred to as channels, with each channel comprising at least a frequency subcarrier and a timeslot. Radio resources/channels may also comprise additional parameters, such as a modulation type or other radio signals characteristics applicable to signals transmitted and received during the operations described herein.

In some embodiments, a first subset of the radio resources assigned for use in sensing applications (e.g., in-cabin radar), while a second subset of the radio resources are assigned for communications functions. One or more of the wireless devices within the vehicle transmit and receive wireless signals, with at least one of the devices processing sensor data generated based on wireless signals that utilize the first subset of radio resources. The sensor data may be used to determine various information within the vehicle, such as the number of occupants in the vehicle, classification of occupants (adults, children, pets, etc.), intrusion detection, vehicle status (e.g., moving, parked), and so on.

The disclosure addresses challenges that arise when multiple such devices are present in the car is related to designing media access control (MAC) and network mechanisms for optimal resource assignment for these mobile private networks. The disclosure further addresses the challenge of co-existence with similar networks in neighboring vehicles.

In various embodiments, the sensing operations carried out using the various wireless devices disclosed herein, and using cellular radio resources, may be combined with machine-learning techniques to further enhance the functionality, including the switching of the devices between various operations as well as increasing the accuracy of the sensing operations. Operations carried out in accordance with the disclosure may include various ones of the following:

Hotspot: A single cellular device could operate wireless hotspot for the car. This device should also be able to communicate with other cars in the vicinity using device-to-device (D2D) communication or broadcast methods, the choice wireless channel/technology (such as channel 7 for Wi-Fi 6) for the hotspot functionality inside the car. This cellular device can also sense user presence within the vicinity of the vehicle.

Intrusion detection: One or more cellular devices in the vehicle could also be used to observer disturbance caused by humans inside the car for intrusion detection.

Occupancy detection: Two or more cellular devices could be used for determining occupancy in the car to the resolution of which seat is occupied.

Occupant classification: A more advanced system can classify occupant for the give seat as adult, child, infant, pet, object, empty, etc. The data could be utilized for safety and personalization functions such as seat belt reminder, airbag deployment, internal climate control, audio control etc.

Driver monitoring: One or more cellular devices could be used to determine status of the driver such as vital signs, gestures, coarse identification, etc.

Passenger monitoring: One or more cellular devices could be used to determine status of the passengers such as vital signs, gestures, coarse identification, and so on.

Vehicular access: A single cellular device may enable remote keyless operation while additional cellular devices could be installed for robust passive access solution to the user. An added advantage of utilizing a cellular communications protocol is availability of the technology on a mobile cellular phone. Depending on the number and location of installed devices, additional services may be provided, such as sentry mode, kick sensing, detection if single/multiple user's zones inside/outside the car could be enabled. An advanced system could also identify the user based on physical profile, walking style (gait), and so on.

In-car entertainment: In addition to sensing applications, various cellular-enabled devices could also be used for streaming in-car entertainment (dual use).

Various embodiments of a systems and methods that utilize cellular devices for sensing operations as well as communications operations are now discussed in further detail.

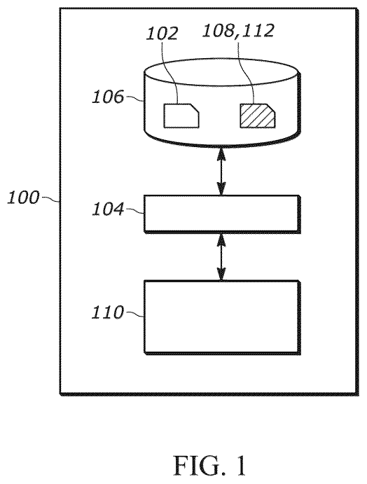

FIG. 1 shows a system 100 for training a neural network, e.g., a deep neural network that may be used with the disclosed method and apparatus implementations in which wireless sensing utilizing cellular radio resources is carried out within and around a vehicle. Such systems may utilize neural networks and machine-learning in carrying out various decisions using data gathered from the sensing operations described herein.

The neural network or deep neural networks shown and described are merely examples of the types of machine-learning networks or neural networks that can be used. The system 100 may comprise an input interface for accessing training data 102 for the neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a cellular radio interface, Bluetooth, Zigbee or Wi-Fi interface or an Ethernet or fiber optic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104. In other embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive as input an output of a previous layer, or for a first layer of the stack of layers, an initial activation, and a part of the input of the stack of layers.

The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by, amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network.

The system 100 may further comprise an output interface for outputting a data representation 112 of the trained neural network, this data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may during or after the training be replaced, at least in part by the data representation 112 of the trained neural network, in that the parameters of the neural network, such as weights, hyper parameters and other types of parameters of neural networks, may be adapted to reflect the training on the training data 102. This is also illustrated in FIG. 1 by the reference numerals 108, 112 referring to the same data record on the data storage 106. In other embodiments, the data representation 112 may be stored separately from the data representation 108 defining the ‘untrained’ neural network. In some embodiments, the output interface may be separate from the data storage interface 104, but may in general be of a type as described above for the data storage interface 104.

In various embodiments, the system for training a neural network may be implemented in a system for sensing in association with vehicular applications, including interior sensing. The system may utilize cellular devices and radio resources associated therewith. The training of a neural network may be utilized in conjunction with certain sensing functions, such as the determining personal identification using wireless signals (e.g., Wi-Fi, UWB, 6G) received at a wireless receiver. The data (e.g., CSI) obtained from the wireless signals may be used to determine the gait and/or other motion characteristics to identify a particular person approaching the vehicle. Embodiments in which the data may also be used for a more coarse identification (e.g., to distinguish between an adult and a child) using the system for training a neural network are also possible and contemplated. Based on the training, the neural network may be used to determine patterns of the particular person and may adjust its operation based thereon. For example, the neural network, upon identifying a particular driver of the vehicle, may cause actuators in the system to carry out adjustments to seats, mirrors, a steering wheel, and so on, according to known personal preferences.

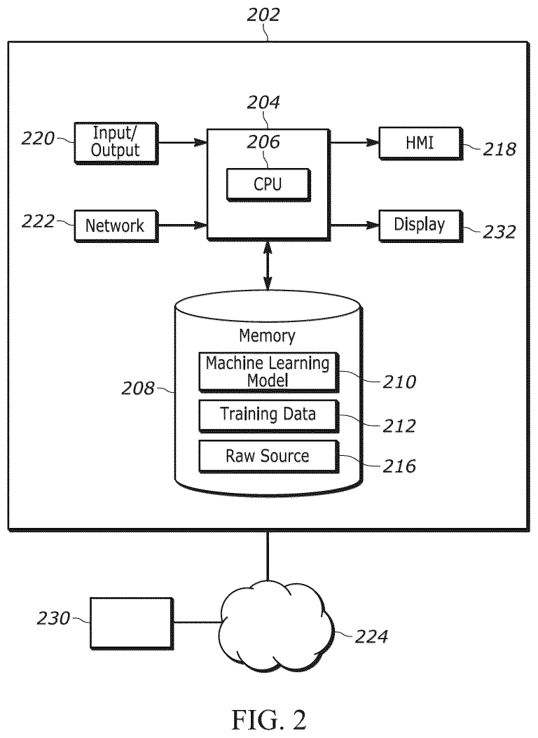

FIG. 2 depicts a system 200 to implement the machine-learning models described herein, for example the deep neural networks (DNNs) used to perform various sensing functions such as personal identification using data obtained from received cellular wireless signals as described above and in further detail below. Other types of machine-learning models can be used, and the DNNs described herein are not the only types of machine-learning models capable of being used in the system of this disclosure. For example, if the input image contains an ordered sequence of pixels after converting CSI values to pixels in an image), a convolution neural network (CNN) may be utilized. The system 200 can be implemented to perform one or more of the sensing operations described herein, and may further generate responses that are based on data generated from such sensing operations.

The system 200 may include at least one computing system 202. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the ×86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The computing system 202 may implement an operating system for managing various aspects of the operation. While one processor 204, one CPU 206, and one memory 208 is shown in FIG. 2, of course more than one of each can be utilized in an overall system.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 or algorithm, a training dataset 212 for the machine-learning model 210, raw source dataset 216.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 6G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224. The information exchange may include the transfer of information using wireless signals transferred using cellular radio resources assigned to a cellular device or cellular network in, e.g., a vehicle such as an automobile. Information in a cellular network may also be exchanged among various base stations thereof.

The computing system 202 may include an input/output (I/O) interface 220 that may be configured to provide digital and/or analog inputs and outputs. The I/O interface 220 is used to transfer information between internal storage and external input and/or output devices (e.g., HMI devices). The I/O interface 220 can include cellular radios in a device (e.g., a smart phone or vehicle-integrated cellular device) for the transmission to and reception of signals from a cellular base station. Assigned radio resources may also be transmitted and received by cellular radios of I/O interface 220 for the performance of various sensing applications as discussed herein. The I/O interface 220 may further include radios for transmission and reception of wireless signals using other protocols, such as Wi-Fi, Bluetooth, and so forth. The I/O interface associated circuitry or bus networks to transfer information to or between the processor(s) and storage. For example, the I/O interface 220 can include digital I/O logic lines which can be read or set by the processor(s), handshake lines to supervise data transfer via the I/O lines; timing and counting facilities, and other structure known to provide such functions. Examples of input devices include a keyboard, mouse, sensors, radios (including cellular radios), etc. Examples of output devices include monitors, speakers, radios, actuators (to cause physical actions to be carried out), etc. The I/O interface 220 may include additional serial interfaces for communicating with external devices (e.g., Universal Serial Bus (USB) interface). The I/O interface 220 can be referred to as an input interface (in that it transfers data from an external input, such as a sensor), an output interface (in that it transfers data to an external output, such as a display), or both.

The computing system 202 may include a human-machine interface (HMI) device 218 that may include any device that enables the system 200 to receive control input. Examples of input devices may include human interface inputs such as keyboards, mice, touchscreens, voice input devices, and other similar devices. The computing system 202 may include a display device 232. The computing system 202 may include hardware and software for outputting graphics and text information to the display device 232. The display device 232 may include an electronic display screen, projector, printer or other suitable device for displaying information to a user or operator. The computing system 202 may be further configured to allow interaction with remote HMI and remote display devices via the network interface device 222.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement a machine-learning algorithm 210 that is configured to analyze the raw source dataset 216. The raw source dataset 216 may include raw or unprocessed sensor data that may be representative of an input dataset for a machine-learning system. The raw source dataset 216 may include video, video segments, images, text-based information, audio or human speech, time series data (e.g., a pressure sensor signal over time), raw or partially processed sensor data (e.g., radar map of objects), wireless signals in terms of CSI, RSSI, CIR. Moreover, the raw source dataset 216 may be input data derived from an associated sensor such as a camera, LiDAR, radar, ultrasonic sensor, motion sensor, thermal imaging camera, wireless receivers, or any other type of sensor that produces associated data with spatial dimensions where there is some notion of a “foreground” and a “background” within those spatial dimensions. References to an input or input “image” herein is not necessarily from a camera, but can be from any of the above-listed sensors. Several different examples of inputs are shown and described with reference to the various figures discussed below. In some examples, the machine-learning algorithm 210 may be a neural network algorithm (e.g., deep neural network) that is designed to perform a predetermined function. For example, the neural network algorithm may be configured to identify defects (e.g., cracks, stresses, bumps, etc.) in a part subsequent to the manufacture of that part but prior to leaving the plant.

The computer system 200 may store a training dataset 212 for the machine-learning algorithm 210. The training dataset 212 may represent a set of previously constructed data for training the machine-learning algorithm 210. The training dataset 212 may be used by the machine-learning algorithm 210 to learn weighting factors associated with a neural network algorithm. The training dataset 212 may include a set of source data that has corresponding outcomes or results that the machine-learning algorithm 210 tries to duplicate via the learning process.

The machine-learning algorithm 210 may be operated in a learning mode using the training dataset 212 as input. The machine-learning algorithm 210 may be executed over a number of iterations using the data from the training dataset 212. With each iteration, the machine-learning algorithm 210 may update internal weighting factors based on the achieved results. For example, the machine-learning algorithm 210 can compare output results (e.g., a reconstructed or supplemented image, in the case where image data is the input) with those included in the training dataset 212. Since the training dataset 212 includes the expected results, the machine-learning algorithm 210 can determine when performance is acceptable. After the machine-learning algorithm 210 achieves a predetermined performance level (e.g., 100% agreement with the outcomes associated with the training dataset 212), or convergence, the machine-learning algorithm 210 may be executed using data that is not in the training dataset 212. It should be understood that in this disclosure, “convergence” can mean a set (e.g., predetermined) number of iterations have occurred, or that the residual is sufficiently small (e.g., the change in the approximate probability over iterations is changing by less than a threshold), or other convergence conditions. The trained machine-learning algorithm 210 may be applied to new datasets to generate annotated data.

The machine-learning algorithm 210 may be configured to identify a particular feature in the raw source data 216. The raw source data 216 may include a plurality of instances or input for which supplementation results are desired. For example, the machine-learning algorithm 210 may be configured to perform coarse identification of occupants within a vehicle (e.g., adult, child, pet, etc.) using sensing information generated by cellular devices that carry out wireless sensing operations. The machine-learning algorithm 210 may be programmed to process the raw source data 216 to identify the presence of the particular features. The machine-learning algorithm 210 may be configured to identify a feature in the raw source data 216 as a predetermined feature (e.g., obstacle, pedestrian, etc.). The raw source data 216 may be derived from a variety of sources. For example, the raw source data 216 may be actual input data collected by a machine-learning system. The raw source data 216 may be machine generated for testing the system. As an example, the raw source data 216 may include reflected wireless signals used in an in-vehicle radar system that utilizes cellular radio resources.

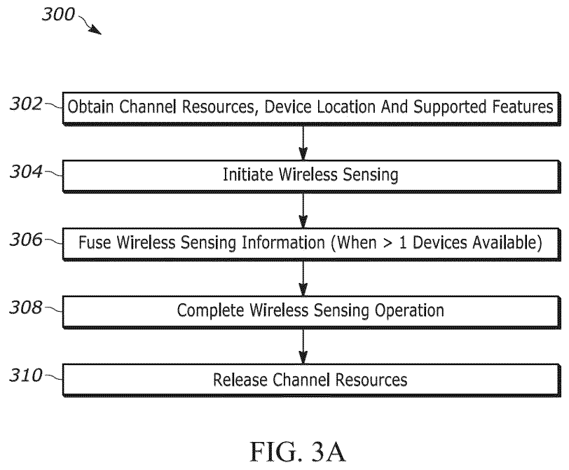

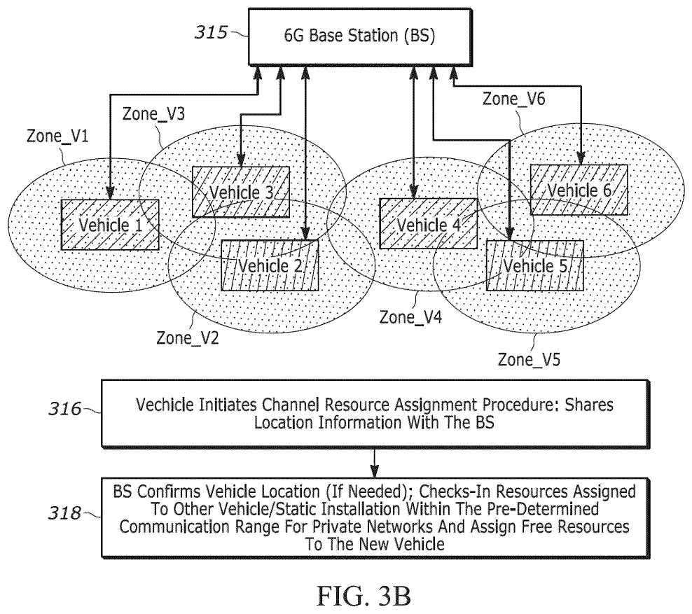

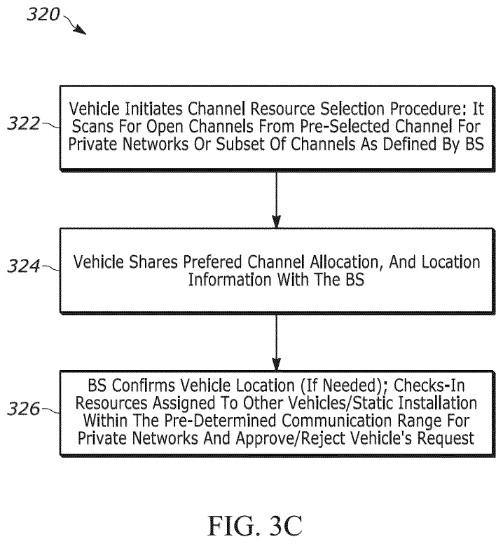

FIG. 3A is a flow diagram of one embodiment of a method for utilizing cellular devices for in-vehicle sensing functions. Method 300 may be carried out using various apparatus embodiments discussed elsewhere herein, including using all or portions of the systems discussed above with reference to FIGS. 1 and 2. Furthermore, an apparatus embodiments capable of carrying out Method 300 but not explicitly discussed herein is also considered to fall within the scope of this disclosure.

Method 300 includes an initiating cellular device within a vehicle obtaining cellular radio resources, and in particular, channel resources based on device location along with supported features (block 302). In obtaining cellular radio resources, the cellular device may contact a base station and receive the resource assignments therefrom. In assigning radio resources to a cellular device within a particular vehicle, the base station may take into account those resources that are assigned to other cellular devices within the vicinity of the vehicle and those expected to be within the vicinity based on their respective paths of travel.

The resources may include assignments for subcarrier frequencies and timeslots per various types of cellular protocols. The cellular device may be one brought into the vehicle by an occupant, or may be a cellular device that is integrated into the vehicle itself. The radio resources that are assigned may include both those used for sensing applications and those used for communications applications (e.g., phone and data). Since multiple cellular devices may be present in the vehicle, the requesting device may perform further assignments to the other, non-requesting devices therein.

A given one of the cellular devices within the vehicle, such as the initiating cellular device from which radio resources were requested, may act as a sub-network controller and thus form a sub-network with other devices within the vehicle.

Thus, a cellular sub-network may have at least one controller, while additional cellular devices in the vehicle are consider as peripheral devices. Once the radio resources are allocated by the base station, the sub-network controller may create a sub-network schedule and assign channel resources to peripherals as per the supported use cases.

After assignment of the radio resources to the one or more cellular devices, wireless sensing is initiated (block 304). The wireless sensing may be carried out by at least the cellular device that requested radio resources from the base station, although multiple other cellular devices within the vehicle may also be used for sensing applications. The sensing applications may include utilizing assigned radio resources for in-cabin radar applications for, e.g., occupant detection and classification, occupant identification, driver and passenger monitoring, and so on. When multiple devices are used to carry out sensing, these devices may serve as both transmitters and receivers for in-cabin radar, thereby providing multiple perspectives of the environment within the vehicle interior. This in turn may result in more accurate sensing and thus result in enhancements to decisions made based on the sensing. For example, with multiple devices carrying out sensing functions within the vehicle interior, in-cabin radar may be used to observe an occupant of the vehicle from two or more angles. This may in turn allow more accurate classification and/or identification of the occupant.

The initiation of wireless sensing in various implementation includes activation of mono-static and/or bi/multi-static sensing using cellular devices within a sub-network formed when multiple cellular devices are present. In mono-static sensing, transmitter and receiver are co-located in same device, e.g., radar. While for bi/multi-static sensing, transmitter and receiver may comprise two or more different devices. In these arrangements, one device transmits signals while one (bi-static) or more (multi-static) other devices receives.

It is noted that a single cellular device may act as a transmitter or a receiver in a sensing operation in the bi/multi-static sensing arrangements. Furthermore, some cellular devices in a bi/multi-static arrangement may act as a transmitter for a first sensing operation (e.g., using a first frequency subcarrier) and a receiver for a second sensing operation (e.g., using a second frequency subcarrier).

Method 300 further includes the fusing of sensing information in a single device in situations where multiple devices are used (block 306). In some embodiments, the single device in which the sensing data is fused may be the same one that requested radio resources from the base station. The requesting device, as noted above, may be a device that is integrated into the vehicle itself, although embodiments in which the cellular device is a portable device brought into the vehicle by an occupant thereof are also possible and contemplated. The fusing of the wireless sensing information into a single device may allow that device to perform additional processing functions and the generation of decisions on actions to be taken based on the data. For example, in a vehicle with some autonomous driving functions, a determination that a driver is impaired based on the sensing information could be used to cause automated control to take over to case the vehicle to pull over to the side of the road and stop.

When more than one sensing device is available in the sub-network, then depending on the sensing application, data from these devices can also be fused together to support the use case. In that case, raw/processed data available from all sensing devices may be fused at central location. The central location may be one of those sensing devices or a computer in the vehicle having higher computational resources. In embodiments with multiple devices carrying out sensing operation, the assignment of radio resources may include designating communications time slots and subcarrier frequencies for communications between the devices.

In fusing the sensing information and making decisions based thereon, a system such as that shown in FIG. 2 may execute a machine-learning model, such as machine-learning model 210. The sensing information provided thereto may be comprised in raw source dataset 216. The machine-learning model 210 may utilize the sensor data from raw source dataset 216, along with relevant data from training dataset 212 to determine actions and generate output signals to be provided to I/O interface 220.

The wireless sensing operations may be considered complete (block 308) at some point in time. For example, if the vehicle is parked and the engine is shut down, at least some (if not all) wireless sensing operations may be discontinued at that time. In response to the discontinuance of wireless sensing operations, the initiating cellular device may contact a base station to indicate release the previously assigned radio resources. In some instances, the base station contacted by the initiating cellular device to release radio resources may be different from the one from which the radio resources were initially assigned.

FIG. 3B is a diagram illustrating the assignment of cellular radio resources to cellular devices within various vehicles within the vicinity of one another, and a method for doing the same. In the example shown, six different vehicles, Vehicle 1-Vehicle 6, are located in six different zones, Zone V1-Zone_V6, respectively. Certain zones overlap with one another in the illustrated example. For example, Zone_V1 overlaps with Zone_V2 and Zone_V3. Similarly, Zone_V4 overlaps with Zone_V2, Zone_V3, Zone_V5, and Zone_V6. The various vehicles within the zones may be moving, and thus, the zones may also move correspondingly. Accordingly, the arrangement of the zones shown here are not static, but instead, may be a snapshot of a particular instance in time.

Each of the vehicles as shown here is in communications with a base station 315, which, in this particular example, supports 6G. Radio resources may be assigned to one or more cellular devices within each of the vehicles shown here by base station 315. In assigning radio resources to the cellular devices within a particular vehicle, consideration is given with regard to their respective locations, including in reference to one another. For example, given the overlap between Zone_V1, Zone_V2, and Zone_V3, base station 315 may avoid assigning particular subcarrier frequencies and corresponding timeslots to more than one vehicle within these zones. In allocating resources in this manner, base station 315 may assign radio resources to prevent interference between two vehicles within overlapping zones.

Base station 315 may further take into consideration the relative motion of each of the vehicles when allocating radio resources to each. Thus, if the motion of Vehicle 1 is expected to bring it in proximity to Vehicle 5 such that Zone_V1 and Zone_V5 will overlap, base station 315 may allocate radio resources to cellular devices in each to avoid or minimize interference when the vehicles pass in close proximity to one another.

From time to time, base station 315 may also re-assign radio resources based on the respective motions of each vehicle. This may occur for various reasons, such as additional vehicle entering the service area of base station 315 while other vehicles leave the service area. Base station 315 may also be in communication with other base stations. The base stations in communication with one another may perform a hand-off when a vehicle (and thus the cellular devices therein) move from the service area of one base station to another. Hand-offs performed between base stations may thus result in re-assignment of radio resources. For example, cellular devices within a moving vehicle may be assigned a first set of radio resources when in a service area of a first base station, and a second set of radio resources when in a service area of a second base station.

A method illustrated by the flow diagram of FIG. 3B includes initiation, by a vehicle (and more particularly, a cellular device therein) of a channel resource assignment procedure though which location information is shared with a base station (block 316). In sharing the location information, a cellular device may also share information regarding its motion and thus, its direction of travel. In some embodiments, when a map application is used for navigation (along with the Global Positioning System, or GPS), the cellular device may share with the base station both the destination and designated route thereto.

In response to receiving the request, the base station, in block 318, checks to see which resources are assigned to other vehicles and any static installations within its pre-determined communication range (or service area) for private networks and assigns free resources to the vehicle (and more particularly, the requesting cellular device therein). In determining which resources are free, the base station may consider direction and planned routes of travel along with resources assigned to other vehicles that may pass within close proximity to the requestor.

FIG. 3C is another embodiment of a method for requesting and assigning cellular radio resources per the present disclosure. Method 320 as shown herein may be carried out by various ones of the apparatus embodiments discussed above and below. Apparatus embodiments capable of carrying out Method 320, but not explicitly discussed herein, are also considered to fall within the scope of this disclosure.

Method 320 includes a vehicle (and more particularly, a cellular device therein) initiating a channel resource selection procedure (block 322). This procedure include a cellular device scanning for open channels from a pre-selected channel used for private networks (e.g., in-vehicle) or a subset of channels defined by a base station. The cellular device initiating the channel selection receiver may be integrated into a vehicle, or may otherwise be a portable cellular device carried into a vehicle by, e.g., the driver or a passenger.

After determining a preferred channel allocation based on the scanning of open channels, the vehicle may share with the base station the preferred channel allocation, along with location information. The base station may then (if needed), determine the vehicle location and perform a check of resources assigned to other vehicles and/or static installations within its pre-determined communication range, and either approve or rejection the vehicle request (block 326). The requested cellular radio resources may be assigned, by the base station, to the vehicle upon approval of the request. If the request is denied, the base station may either assign other radio resources to the vehicle, or may request the vehicle provide alternate preferences.

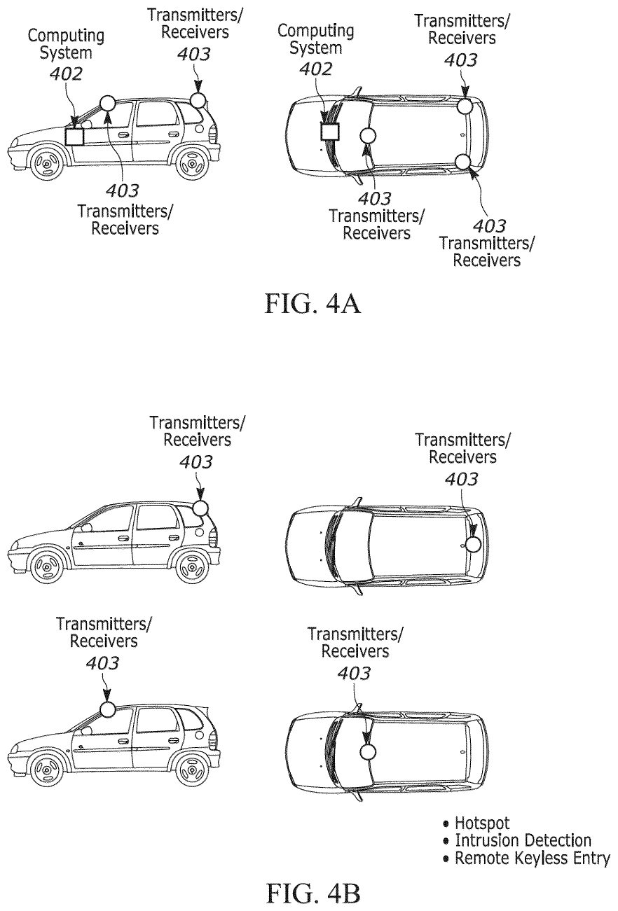

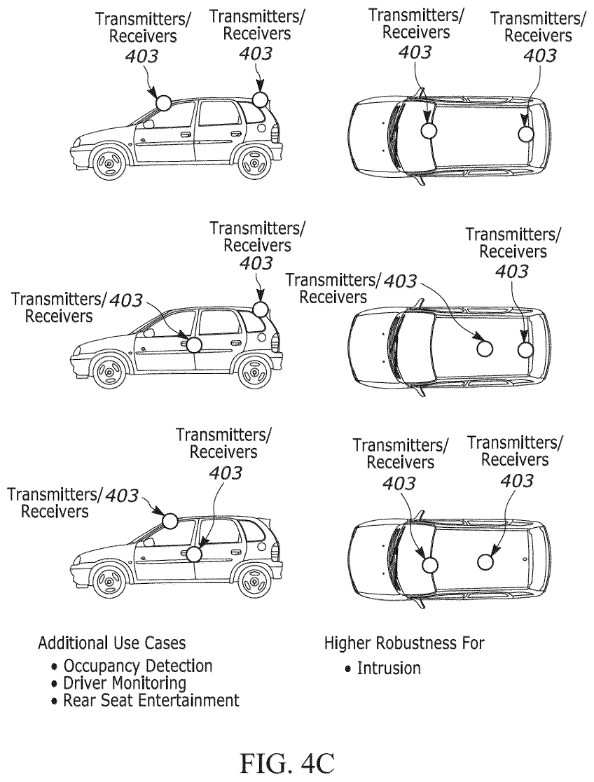

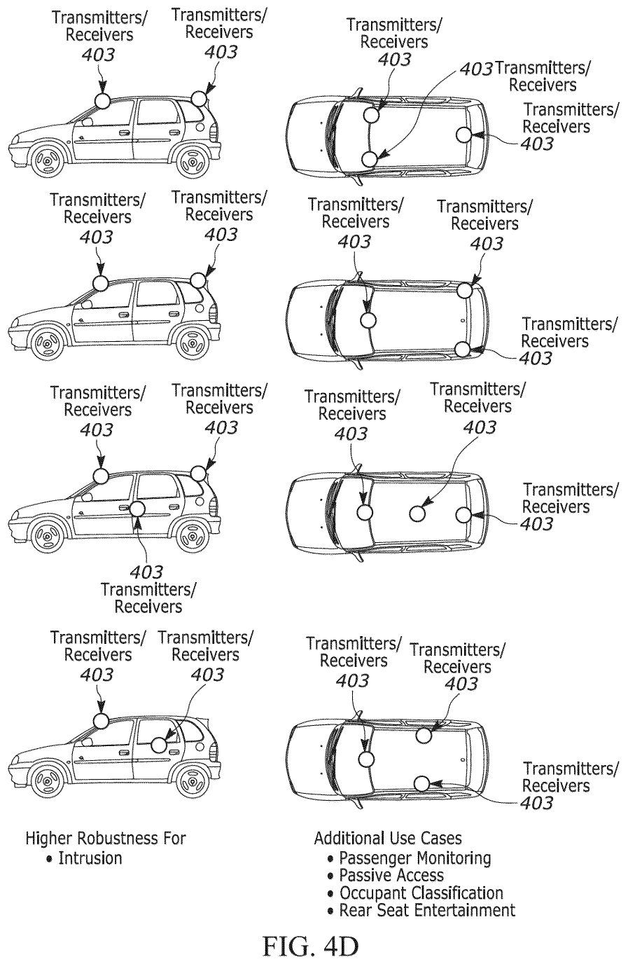

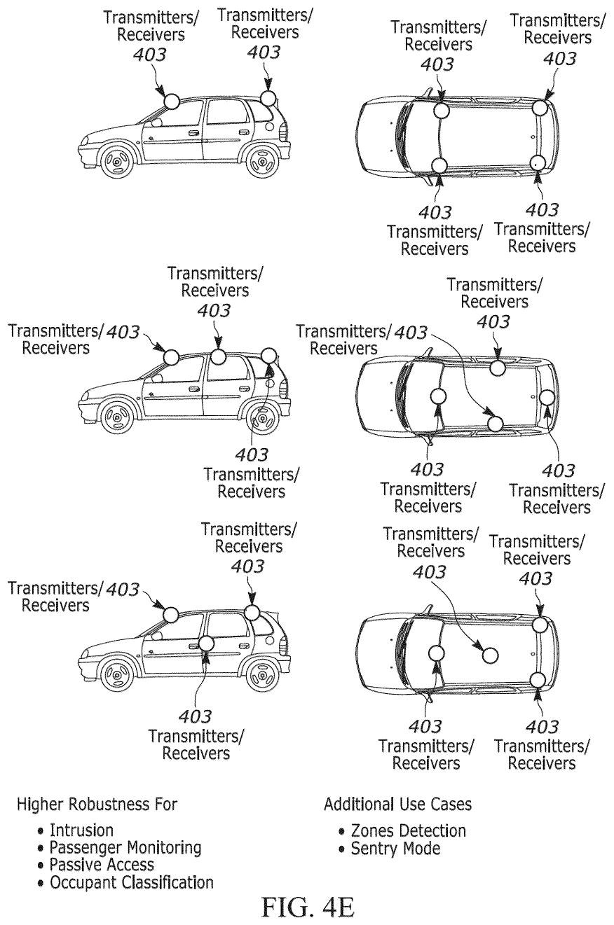

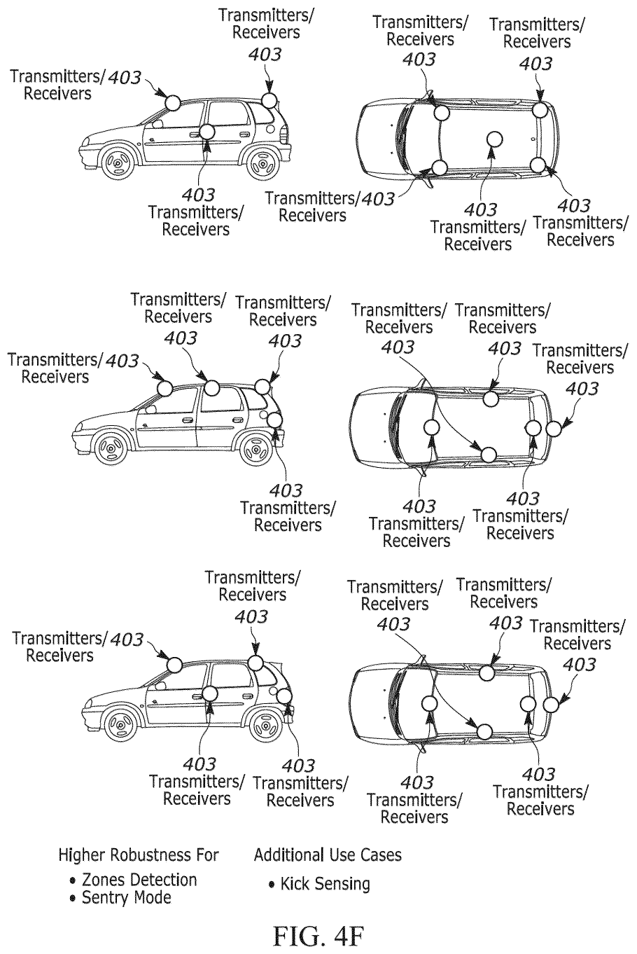

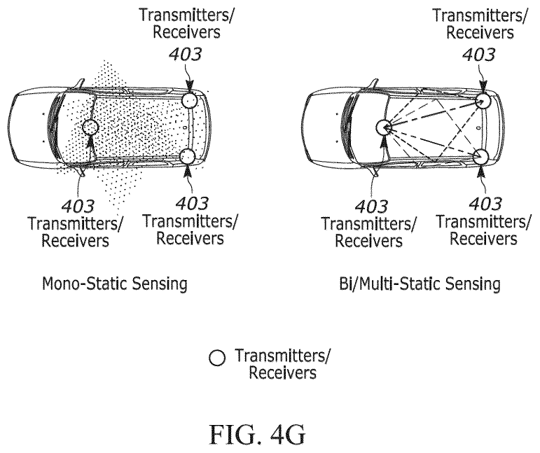

FIGS. 4A-4G illustrate various sensor configurations within a vehicle for systems that perform in-vehicle sensing. In particular, each of the examples illustrates an arrangement of devices 403 that include transmitters and receivers capable of cellular communications. These devices may include at least one cellular device integrated into the vehicle itself and/or one or more other cellular devices (e.g., smart phones, tablet computers, etc.) that are portable and brought into the computer.

The vehicle shown in FIG. 4A includes a computing system 402. It is noted that this system is not shown in FIGS. 4B-4G, although it is to be understood that such a unit may be present in any of these embodiments. It is to be further understood that in some embodiments, a computing system 402 may be integrated into a cellular device that includes transmitters/receivers 403, and that such devices may be portable or integrated into the vehicle itself.

Computing system 402 may carry out a variety of functions. These functions may include the functions discussed above with reference to FIGS. 1 and 2 with regard to training a neural network and executing a machine-learning model. Accordingly, computing system 402 may include various I/O devices 220, a network interface device 222, and a memory 208 (including random access memory as well as bulk storage) with a machine learning model 210, training data 212, and raw source data 216 stored thereon. Computing system 402 may also include HMI 218 and a display 232. In some implementations, such as those utilizing touch screens, HMI 218 may be at least partly integrated into display 232. The display 232 may be used to convey various information to the driver and/or other occupants of the vehicle, including the number of occupants, classification of occupants, status of occupants, and so on. For example, display 232 may show to the driver of the vehicle the number of occupants therein, based on outputs from a sensing application operable to detect vehicle occupancy.

In some embodiments, computing system 402 may include cellular radios, and may thus be the device from which requests for radio resources are relayed to a base station. Computing system 402 may also perform the assignment of cellular radio resources to other devices within the vehicle upon their allocation from the base station. In assigning radio resources, computing system 402 may assign a first subset of radio resources to various cellular devices for performing sensing operations and a second subset of radio resources to cellular devices for other functions (e.g., such as internet access via a Wi-Fi hotspot). Some cellular devices may be assigned radio resources from both subsets, while other devices may be assigned radio resources from only a single one of the subsets.

During sensing operations, computing system 402 may receive the raw sensor data from various ones of the transmitters/receivers 403. The raw sensor data may be processed and used to generate one or more outputs from the system. The processing may include the execution of various machine-learning models using both training data and the raw source data. Computing system 402 may generate a wide variety of outputs based on the sensing, such as temperature control outputs, seat position, volume control of audio devices within the vehicle and so on.

It is noted that the functions carried out by computing system 402 do not necessarily have to carried out by a device that is permanently integrated into the vehicle. For example, a portable device brought into the vehicle may be coupled (via a wired or wireless connection) to a vehicular system and become designated as a controller, while any other devices in the vehicle may be designated as peripheral devices that operate in accordance with instructions from the controller. It is further noted that some of the transmitters/receivers 403 may be integrated into the vehicle even though they do not otherwise provide the same functionality of computing system 402 or a portable cellular device brought into the vehicle by the driver or a passenger. In some embodiments, at least some of the computing functions carried out by computing system 402 may be distributed among multiple devices within the vehicle at a given moment.

The system shown in the various drawings may carry out an algorithm that includes a number of different operations. A first operation includes the obtaining of channel resources, device location, and supported features. This includes negotiating with a base station, such as a 6G base station, for a set of resources to maintain connectivity between the vehicle and cloud/infrastructure to which the base station is coupled.

Given that communication within the car or with the access device for various ones of the devices is also cellular-based, a determination of free channel resources for these functions and advertising the same to the nearby vehicles may be carried out. This could mean reserving some channels within a cellular band for peer-to-peer broadcasting. The channels could be assigned by the cellular network infrastructure (e.g., base stations) in some implementations. Alternatively, the base station (and more generally, cellular provider) may carry out the resource allocation based on the location of the various vehicles relative to one another to optimize spatial reuse. As another alternative, illustrated in FIG. 3B, a requesting vehicle may scan for open channel resources and accordingly inform a base station about its preferred choices, with the base station affirming or rejecting these requests.

With multiple cellular devices present in a vehicle at a given time, one of these devices is designated as controller of the sub-network and is responsible for communicating with the BS for the assignment of resources and controlling the network. Such a cellular device may be, as noted elsewhere, integrated into the vehicle or may be a device that is brought into the vehicle by a driver or passenger. The controller of the sub-network may be chosen based on its respective functionality. As an example, a device supporting wireless hotspot functionality could be sub-network controller. Another option could be that controller functionality (software) is executed on another device with more resources (such as computer integrated into the vehicle) while a cellular device (such as hotspot) is used for communicating with the base station.

Wireless sensing in accordance with the disclosure may be carried out in various ways. For example, devices operating in the 4-7 GHz (sub-10 GHz band) band may support cellular communication and sensing via channel state information estimated at the receiving devices. Devices operating in mm-wave bands with assigned channels/bands in 20-80 GHz range supporting radar functionality using orthogonal frequency division multiplexing (OFDM), and may support other modulation schemes such as FMCW and orthogonal time-frequency space (OFTS). Devices operating in the sub-THz region with assigned channels/bands in 100-300 GHz band may support radar functionality using OFDM and other modulation technologies such as FMCW and OTFS.

Some devices may be capable of joint communication and sensing (JCAS), having the ability to transmit and receive wireless signals in two or more of the above-mentioned bands, with the further capability of supporting both sensing and communications functions either concurrently or by dynamically switching between the two as needed. The disclosure further contemplates that the radios of some devices may support radar functionality in the mm-wave and sub-THz bands could be combined in the same device with radios supporting cellular communications in the sub-10 GHz band (with the radios capable of concurrent operation due to the band separation). The communications channel in such implementations may be referred to as a sidelink communications channel.

FIG. 4B illustrates two different implementations with a single transmitter/receiver 403 in the vehicle. The device comprising transmitters/receivers 403 may be configured to communicate with an in-vehicle computing device (not shown here) similar to computing device 402 of FIG. 4A. Alternatively, one of the wireless devices comprising an instance of transmitters/receivers 403 may perform the functions that would otherwise be performed by an in-vehicle computing device.

In the examples of FIG. 4B, the single cellular device comprising transmitters/receivers 403 in each example may conduct mono-static sensing, and may further conduct cellular communications functions. While it is possible that other wireless devices are present in the vehicle, these devices, in this particular implementation, are not considered part of the sub-network used for sensing purposes, although they may have internet access via a hotspot provided by the device comprising transmitters/receivers 403. Other suitable applications for this implementation includes intrusion detection and remote keyless entry.

FIG. 4C illustrates three different implementations that include two cellular devices comprising transmitters/receiver 403. Either or both of the devices may operate to perform mono-static or bi-static sensing as discussed above. Additionally, one or both of the devices may be configured to communicate with an in-vehicle computing device, if present. Alternatively, one of the devices may perform the additional role that would otherwise be carried out by an in-vehicle computing device. One of the cellular devices comprising an instance of transmitters/receivers 403 may be designated as a controller of a sub-network that includes the other device, with the other device being designated as a peripheral device. The controller device may request radio resources from a cellular base station and may assign the resources between itself and the other peripheral device. This may include assigning radio resources of a first subset for sensing applications and radio resources of a second subset for communications applications. The arrangements shown in FIG. 4C may have enhanced robustness for intrusion detection, and may also support additional sensing use cases for occupancy detection and driver monitoring, while also providing a communications use case for rear seat entertainment.

FIG. 4D illustrates four different implementations that include three different cellular devices having respective instances of transmitters/receivers 403. One of these cellular devices may be designated the controller of a sub-network, and may additionally communicate with an in-vehicle computing device (if present; not shown here). The other two devices are designated as peripheral devices of a sub-network that includes the controller. The controller may request radio resources from a base station and, once granted, assign radio resources amongst the devices of the network. The assigned radio resources may include a first subset designated for sensing applications and a second subset designated for communications application.

The controller may allocate radio resources in different ways. For example, the controller may allocate radio resources from the first subset to two different ones of the cellular devices that comprise transmitters/receivers 403, while allocating radio resources from the second subset to a different one of the cellular devices. In another implementation, radio resources from both the first and second subsets may be allocated to each of the cellular devices, controller and peripherals included. Various devices may perform sensing and communications functions, using the first and second sets of radio resources, respectively. This may include using radio resources from the first and second subsets concurrently or in an alternating fashion.

With respect to applications, the arrangements illustrated in FIG. 4D may be capable of carrying out any of those discussed with reference to the embodiments of FIGS. 4A-4C. Additional use cases for the illustrated arrangements include passenger monitoring, passive access, occupant classification, and rear seat entertainment.

FIG. 4E illustrates three different example arrangements that include four cellular devices comprising a respective one of transmitter/receivers 403 which may be used to form an in-vehicle sub-network including one controller and three peripheral devices. As with the examples above, the various cellular devices may be assigned radio resources from the first subset (for sensing applications), the second subset (for communications applications), or both. In addition to providing high robustness for the sensing applications discussed above, the arrangement of FIG. 4E supports applications including zone detection and sentry mode. Zone detection provides additional granularity for occupancy sensing identifying specific and/or pre-determined areas inside the vehicle referred to as zones. These zones could include areas for driver, front passenger, central console, rear seats, trunk, foot wells and so on. Further, the additional devices could also support determining zones for the access device or the user outside the vehicle. E.g. front of the car, back of the car, around trunk, around driver door, front passenger door, rear passenger doors, roof of the car, under the car and so on. Sentry mode allows detection of person around the parked vehicle within in pre-defined perimeter of the vehicle and accordingly allow access for legitimate drivers or raise alarms for potential intruders (including recording video).

FIG. 4F illustrates three different example arrangements that include five cellular devices that each comprise a respective one of transmitters/receivers 403. This may enable a sub-network to be formed with one controller and four peripheral devices. As with the other arrangements, various ones of the devices may be assigned radio resources from the first subset, the second subset or both. In addition to enabling the applications discussed above, the various arrangements shown support the application of kick sensing. Kick sensing allows user to open the doors generally trunk with leg movements/gestures allowing hands free access and operation when approaching the vehicle, generally, useful when carrying items in hands (e.g. grocery bags). In this case, the system determines whether the user is legitimate user to allow vehicular access and validates the pre-determined gestures for automatic door opening.

FIG. 4G illustrates an arrangement with three cellular devices to illustrate the difference between mono-static sensing and bi/multi-static sensing. It is noted that many devices may support both types of sensing, even if the capability is not utilized in a particular implementation. In the example on the left, one of the devices is granted more sensing radio resources as it may require large time window for the assigned sensing use case. In mono-statics case, these slots are used by devices for radar operation. In bi-static/multi-static mode (on the right side of the drawing), these channel resources are used by assigned transmitter to transmit while (pre-determined) one or more devices listens. For multi-static sensing, sensors fusion may be carried out to fuse data from multiple receivers to determine the sensed operation/activity.

As noted above, some devices can support both mono-static and bi/multi-static sensing. Devices utilizing radar and sidelink communication may utilize mono-static sensing when operating radar while utilizing bi/multi-static sensing when using sidelink.

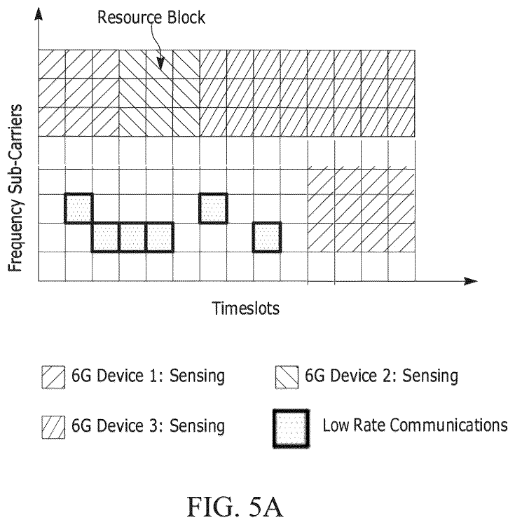

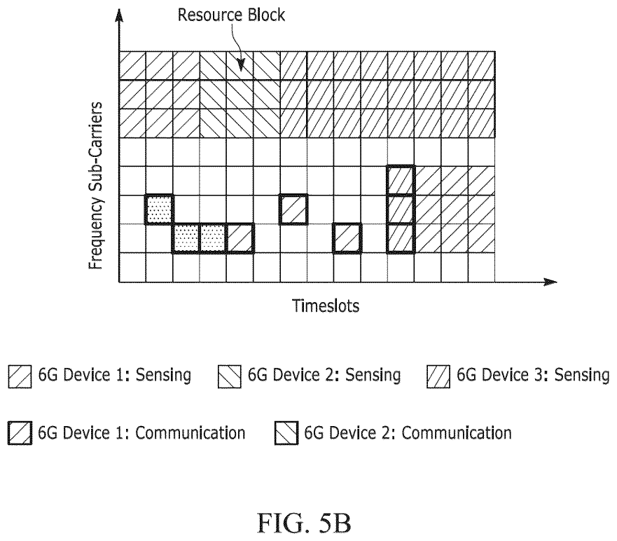

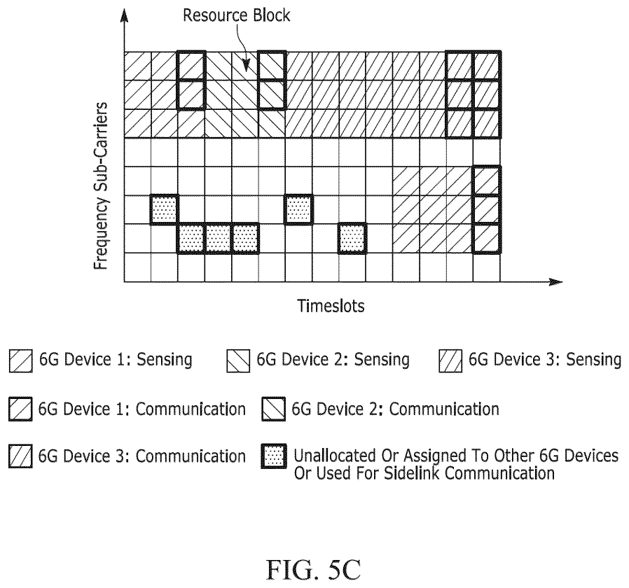

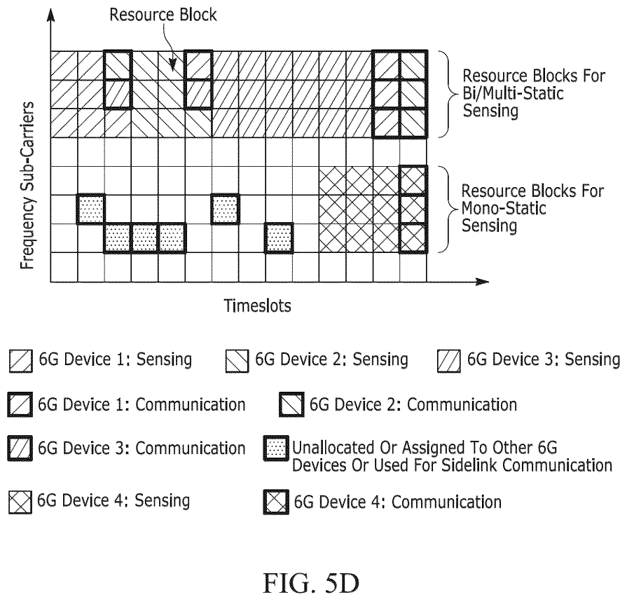

FIGS. 5A-5D illustrate various examples of resource assignment for in-vehicle sensing and communications with a base station. Each example illustrates radio resource assignments, or channel assignments, where each channel comprises a frequency sub-carrier and a timeslot.

The example of FIG. 5A corresponds to an arrangement that includes three devices configured for use with 6G networks. Dedicated channels are assigned to each of Device 1, Device 2, and Device 3, with another subset of channels assigned for low rate communications. The communication channels may be used by any of the three devices based on availability However, Device 3 in this example is allocated a more radio resources for sensing than Devices 1 and 2 to provide a larger time window for the assigned sensing use case (e.g. vital signs detection such as breathing rate or heart rate requiring larger time windows). In mono-static case, these slots are used by Device 3 for radar operation. In bi-static/multi-static mode, these channel resources are used by the assigned transmitter to transmit while (pre-determined) one or more of the other devices listen. For multi-static sensing, sensor fusions may be carried out to fuse data from multiple receivers to determine the sensed operation/activity. In this example, the illustrated channel resource assignment may allow the collection of at central device for processing of the raw data and subsequent computation.

FIG. 5B is another example that includes three devices. Each of Device 1, Device 2, and Device 3 are allocated channels for carrying out various sensing operations. Device 1 and Device 2 are additionally allocated communication channels. In this case, the devices could either make individual sensing decisions utilizing sensing data from their respective sensing timeslots, and then inform the controller about their decision using respective communication timeslots, or share their processed data with central controller during their respective communication timeslot.

FIG. 5C also shows an example that includes three devices. Sensing and communications channels are assigned for each of Devices 1, 2, and 3. This example also includes a group of channels that are either unallocated, assigned to additional devices (beyond Devices 1, 2, and 3), or used for sidelink communications among any of the devices present in the vehicle. In this case, communications timeslots may be allocated on the same sub-carriers allocated for sensing.

FIG. 5D illustrates an example with at least four devices, with sensing channels and communications channels assigned to each of Devices 1, 2, 3, and 4. This example also includes a group of channels that are either unallocated, assigned to other devices (beyond Devices 1, 2, 3, and 4), or otherwise used for sidelink communication. Each of Devices 1, 2, 3, and 4 have channels allocated thereto for carrying out sensing operations. Additionally, each of Devices 1, 2, 3, and 4 have communications channels allocated thereto. In various implementations, a given one of the devices may carry out sensing operations concurrently with performing sensing operations, particularly when there is no frequency band overlap between the two.

In various implementations, channel assignment may include contiguous timeslots and/or contiguous frequencies. Furthermore, assignments of channels to the various devices may be based at least in part on communications requirements (data rate, latency, etc.) and sensing requirements (bandwidth, time window, etc.) of the particular use cases for which they are to be utilized. Channel assignments may also be time-bound by the base station in certain situations, and may further be bound by the geographic location as the vehicle in which the devices are located moves between different areas.

The disclosure further contemplates that allocation of radio resources/channels may be based on priority of contending applications. Priority of an application could be based on whether an application is safety critical or is provided to enhance user experience. Examples of safety critical applications include those that determine if seat belts are fastened for all vehicle occupants, those that determine a driver's vital signs, and any other application that could directly affect the safety of the vehicle and its occupants. Examples of applications to enhance user experience could be one that controls a communications bandwidth to various devices in the vehicle, applications to adjust seat preferences for passengers, and so on. A safety critical application may be designated to have a higher priority than one that is provided primarily for enhancement of user experience. Priority of user experience-based applications can also be determined based on user's (operator or owner) input. Priority of applications could also be affected based on car state: locked and parked, static vs moving car, etc. For example, a seatbelt monitoring application may be given a lower priority at times the vehicle is parked and a higher priority when the vehicle is in motion.

During channel assignment, if a request is declined or it is determined that allocated channels are not capable of carrying out the sensing application then appropriate message (warning/alarm) may be provided to the operator (e.g., via an HMI 218 and/or display 232 of computing system 202 shown in FIG. 2). Furthermore, if a particular request is declined due to a determination that allocated channels are not capable of carrying out the particular sensing application, such channel resources may be freed up for allocation to other lower priority applications.

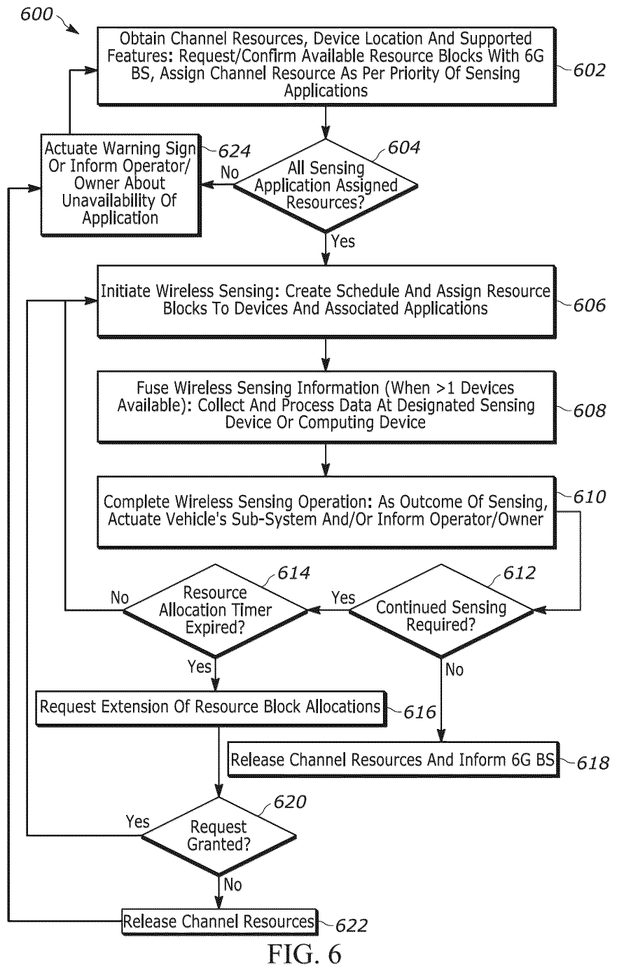

FIG. 6 shows an example of a method for utilizing cellular resources for in-vehicle sensing. Method 600 as shown in FIG. 6 may be carried out using any of the apparatus described herein, and may incorporate other methodologies, in full or part, as also described herein. Apparatus embodiments capable of carrying out Method 600, but not otherwise discussed herein, are considered to fall within the scope of this disclosure.

Method 600 includes obtaining channel resources based on device location and supported features, which includes a request sent to a base station (6G in this non-limiting example) and confirmation as to whether all requested channels are available and assignments per priority of sensing applications (block 602). If not all requested channels are available (block 604, no), a warning sign is actuated to inform an owner or operator of the vehicle about the unavailability of a particular application (block 624).

If all of the requested channel resources are available (block 604, yes), a schedule is created and the channel resources are assigned to devices and associated sensing application to initiate the wireless sensing (block 606). The assignment to the various devices may be carried out a particular device designated as a controller of a sub-network that includes all devices in the vehicle. The controller may also be the same device from which the request for resources was sent to the base station.

After assignments have been carried out, the sensing operations may be carried out, with raw sensing data fused (i.e. consolidated) onto one particular device for processing (block 608). The particular device upon which the sensing data is fused may be the controller device, an in-vehicle computing device, or other designated device. The processing of the sensing data may result in a completion of the sensing operation (block 610), which may result in actuation of a particular vehicle subsystem (e.g., adjusting of a seat position, etc.) or a notification to the operator or owner of the vehicle.

If continued sensing is required (block 612, yes) and a resource allocation timer has not expired (block 614, no), Method 600 returns to block 606 and sensing operations continue. If continued sensing is desired (block 612) but the resource allocation timer has expired (block 614, yes), the controller or another device in the vehicle may request an extension of the resource allocations (block 616). If the request is granted (block 620, yes), Method 600 returns to block 606 and the sensing operations continue. If the request is not granted (block 620, no), the channel resources are released (block 622) and a warning is presented to the own/operator regarding the unavailability of the sensing applications (block 624), with the method then returning to block 602). If continued sensing is not required, (block 612, no), the resources may be released and the base station is informed of the same (block 618).

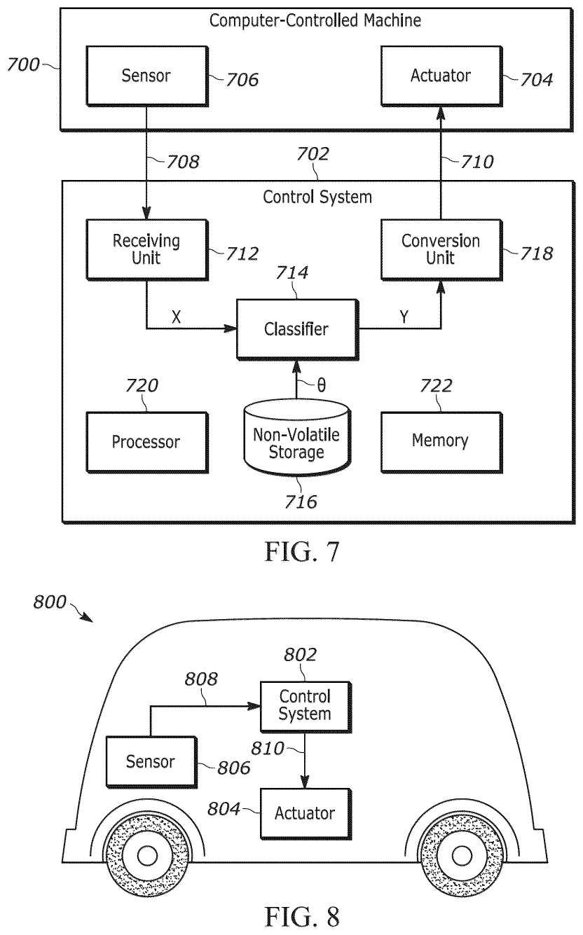

FIG. 7 depicts a schematic diagram of an interaction between a computer-controlled machine 700 and a control system 702. Computer-controlled machine 700 includes actuator 704 and sensor 706. Actuator 704 may include one or more actuators and sensor 706 may include one or more sensors. Sensor 706 is configured to sense a condition of computer-controlled machine 700. Sensor 706 may be configured to encode the sensed condition into sensor signals 708 and to transmit sensor signals 708 to control system 702. Sensor 706 in various embodiments includes cellular devices that carry out sensing operations as discussed above with reference to FIGS. 1-6. However, sensor 706 may include other types of sensors as well. Non-limiting examples of the other types of sensors that may be embodied by sensor 706 include wireless receivers (other than the cellular devices discussed elsewhere), video, radar, LiDAR, ultrasonic and motion sensors, as described above with reference to FIGS. 1-2. Embodiments in which a combination of different sensors are also possible and contemplated.

In embodiments where sensor 706 comprises a radio that utilizes cellular radio resources, various interior sensing functions may be carried out by the same. These functions may be used for occupant detection, occupant classification, occupant identification, intrusion detection, and a number of other functions discussed elsewhere herein. Various information obtained from received wireless signals may be used to train a machine-learning model, such as those discussed above with reference to FIGS. 1 and 2.

Control system 702 is configured to receive sensor signals 708 from computer-controlled machine 700. As set forth below, control system 702 may be further configured to compute actuator control commands 710 depending on the sensor signals and to transmit actuator control commands 710 to actuator 704 of computer-controlled machine 700. For example, using the vehicular in-cabin sensing systems discussed elsewhere in the disclosure, control system 702 may generate actuator control commands to adjust various parameters of an in-vehicle environment, such as a seat position, position of mirrors, temperature within the vehicle interior, and so on. Warning and indications may also be generated to provide information to various occupants of the vehicle.

As shown in FIG. 7, control system 702 includes receiving unit 712. Receiving unit 712 may be configured to receive sensor signals 708 from sensor 706 and to transform sensor signals 708 into input signals x. In an alternative embodiment, sensor signals 708 are received directly as input signals x without receiving unit 712. Each input signal x may be a portion of each sensor signal 708. Receiving unit 712 may be configured to process each sensor signal 708 to product each input signal x. Input signal x may include data corresponding to, e.g., wireless cellular signals received by sensor 706.

Control system 702 includes a classifier 714. Classifier 714 may be configured to classify input signals x into one or more labels using a machine-learning (ML) algorithm, such as a neural network described above. Classifier 714 is configured to be parametrized by various sensing parameters in accordance with sensing applications carried out within the interior of the vehicle. The parameters may be stored in and provided by non-volatile storage 716. Classifier 714 is configured to determine output signals y from input signals x. Each output signal y includes information that assigns one or more labels to each input signal x. Classifier 714 may transmit output signals y to conversion unit 718. Conversion unit 718 is configured to covert output signals y into actuator control commands 710. Control system 702 is configured to transmit actuator control commands 710 to actuator 704, which is configured to actuate computer-controlled machine 700 in response to actuator control commands 710. In another embodiment, actuator 704 is configured to actuate computer-controlled machine 700 based directly on output signals y.

Upon receipt of actuator control commands 710 by actuator 704, actuator 704 is configured to execute an action corresponding to the related actuator control command 710. Actuator 704 may include a control logic configured to transform actuator control commands 710 into a second actuator control command, which is utilized to control actuator 704. In one or more embodiments, actuator control commands 710 may be utilized to control a display instead of or in addition to an actuator.

In another embodiment, control system 702 includes sensor 706 instead of or in addition to computer-controlled machine 700 including sensor 706. Control system 702 may also include actuator 704 instead of or in addition to computer-controlled machine 700 including actuator 704.

As shown in FIG. 7, control system 702 also includes processor 720 and memory 722. Processor 720 may include one or more processors. Memory 722 may include one or more memory devices. The classifier 714 (e.g., machine-learning algorithms, such as those directed to a pre-trained classifier) of one or more embodiments may be implemented by control system 702, which includes non-volatile storage 716, processor 720 and memory 722.

Non-volatile storage 716 may include one or more persistent data storage devices such as a hard drive, optical drive, tape drive, non-volatile solid-state device, cloud storage or any other device capable of persistently storing information. Processor 720 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 722. Memory 722 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 720 may be configured to read into memory 722 and execute computer-executable instructions residing in non-volatile storage 716 and embodying one or more ML algorithms and/or methodologies of one or more embodiments. Non-volatile storage 716 may include one or more operating systems and applications. Non-volatile storage 716 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by processor 720, the computer-executable instructions of non-volatile storage 716 may cause control system 702 to implement one or more of the ML algorithms and/or methodologies in conjunction with the sensing operations disclosed herein. Non-volatile storage 716 may also include ML data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIG. 8 depicts a schematic diagram of control system 702 configured to control vehicle 800, which may be an at least partially autonomous vehicle. Vehicle 800 includes actuator 704 and sensor 706. Sensor 706 may include various cellular devices as described above which use cellular radio resources to carry out sensing applications in the interior of vehicle 800. However, sensor 706 may also embody one or more additional sensors, including one or more video sensors, cameras, radar sensors, ultrasonic sensors, wireless transmitters and/or receivers (including cellular radios), LiDAR sensors, and/or position sensors (e.g., GPS). One or more of the one or more specific sensors may be integrated into vehicle 800. Alternatively or in addition to one or more specific sensors identified above, sensor 706 may include a software module configured to, upon execution, determine a state of actuator 704. Some of the sensors may also be implemented on, e.g., portable cellular computing devices, such as a smart phone, whose presence in the vehicle may be on a temporary rather than persistent basis.

Classifier 714 of control system 702 of vehicle 800 may be configured to detect objects in the vicinity of vehicle 800 dependent on input signals x. In such an embodiment, output signal y may include information characterizing the vicinity of objects to vehicle 800. Actuator control command 710 may be determined in accordance with this information. The actuator control command 710 may be used to avoid collisions with the detected objects. In some embodiments, classifier 714 may utilize wireless signals (e.g., Bluetooth signals) in the vehicle for coarse (and in some cases, fine) personal identification and vehicle occupant classification purposes in accordance with the discussion above. For example, classifier 714 may utilize the wireless signals to identify a particular driver of the car, thereby enabling control system 702 to adjust a seat position for the particular driver upon entry into the vehicle.

In embodiments where vehicle 800 is an at least partially autonomous vehicle, actuator 704 may be embodied in a brake, a propulsion system, an engine, a drivetrain, or a steering of vehicle 800. Actuator control commands 710 may be determined such that actuator 704 is controlled such that vehicle 800 avoids collisions with detected objects. Detected objects may also be classified according to what classifier 714 deems them most likely to be, such as pedestrians or trees. The actuator control commands 710 may be determined depending on the classification. In a scenario where an adversarial attack may occur, the system described above may be further trained to better detect objects or identify a change in lighting conditions or an angle for a sensor or camera on vehicle 800.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method for utilizing cellular resources to perform in-cabin sensing in a vehicle, the method comprising:
initiating communications, using a first cellular communications device in a vehicle, with a remote cellular station to request a plurality of radio resources;
receiving, from the remote cellular station, the plurality of radio resources;
allocating a first subset of the plurality of radio resources for use by one or more sensing applications;
allocating a second subset of the plurality of radio resources for use by one or more communications applications;
transmitting and receiving wireless signals, using the first cellular communications device and the first and second subsets of radio resources; and
processing, using a computing device coupled to the a first cellular communications device, sensor data generated based on the transmitting and receiving of the wireless signals of the first subset, wherein processing the sensor data includes determining, based on the sensor data, occupancy of the vehicle and displaying, to a driver of the vehicle, the occupancy of the vehicle.

2. The method of claim 1, wherein processing the sensor data further comprises classifying an occupant of a given seat of the vehicle according to one or more characteristics.

3. The method of claim 1, wherein processing the sensor data further comprises determining one or more characteristics of a driver of vehicle, the one or more characteristics including one or more vital signs of the driver.

4. The method of claim 1, wherein processing the sensor data further comprises providing identification of occupants of the vehicle.

5. The method of claim 1, further comprising using the first cellular communications device to provide one or more of the following:
internet access, via a wireless hotspot, to a wireless communications device in the vehicle;
parking assistance;
vehicular access control;
intrusion detection.

6. The method of claim 1, further comprising:
releasing the plurality of radio resources to the remote cellular station based on movement of the vehicle;
obtaining a second plurality of radio resources from a second cellular station based on the movement of the vehicle; and
allocating first and second subsets of the second plurality of radio resources to the one or more sensing applications and the one or more communications applications, respectively.

7. The method of claim 1, further comprising:
allocating the first subset of radio resources to the first cellular communications device and a second cellular communications device; and
allocating the second subset of radio resources to a third cellular communications device that is separate from the first and second cellular communications devices.

8. The method of claim 1 further comprising allocating ones of the first subset of radio resources based on respective priorities of sensing applications that use assigned ones of the first subset of radio resources, wherein a first priority level comprises safety critical sensing applications, and wherein a second, lower priority level comprises user experience-based sensing applications.

9. A system for performing in-cabin sensing in a vehicle interior utilizing cellular resources, the system comprising:
a first cellular communications device implemented in an interior of a vehicle, wherein the first cellular communications device is configured to:
initiate communications with a remote cellular station to request a plurality of radio resources;
receive, from the remote cellular station, the plurality of radio resources;
allocate a first subset of the plurality of radio resources for use by one or more sensing applications; and
allocate a second subset of the plurality of radio resources for use by one or more communications applications;
transmit and receive wireless signals using the first and second subsets of radio resources; and
a computing device coupled to the first cellular communications device, wherein the computing device is configured to process sensor data, generated using the first subset of the plurality of radio resources and the wireless signals, to execute the one or more sensing applications, wherein processing the sensor data includes determining, based on the sensor data, occupancy of the vehicle and displaying, to a driver of the vehicle, the occupancy of the vehicle.

10. The system of claim 9, wherein the computing device is configured to, using the sensor data, classify an occupant of a given seat of the vehicle according to one or more characteristics.

11. The system of claim 9, wherein the computing device is configured to, using the sensor data, determine one or more characteristics of a driver of the vehicle, the one or more characteristics including one or more vital signs.

12. The system of claim 9, wherein the computing device is further configured to, using the sensor data, provide identification of occupants of the vehicle.

13. The system of claim 9, wherein the first cellular communications device is configured to provide internet access, via a wireless hotspot, to a wireless communications device in the vehicle.

14. The system of claim 9, wherein the first cellular communications device is further configured to:
release the plurality of radio resources to the remote cellular station based on movement of the vehicle;
obtain a second plurality of radio resources from a second cellular station based on the movement of the vehicle; and
allocate first and second subsets of the second plurality of radio resources to the one or more sensing applications and the one or more communications applications, respectively.

15. The system of claim 9, wherein the first cellular communications device is further configured to:
allocate the first subset of radio resources to the first cellular communications device and a second cellular communications device; and
allocate the second subset of radio resources to a third cellular communications device that is separate from the first and second cellular communications devices.

16. The system of claim 9, wherein the first cellular communications device is configured to allocate ones of the first subset of radio resources based on respective priorities of sensing application that use assigned ones of the first subset of radio resources, wherein a first priority level comprises safety critical sensing applications, and wherein a second, lower priority level comprises user experience-based sensing applications.

17. A non-transitory computer readable medium storing instructions, that when executed by a computing system, cause operations to be carried out comprising:
causing a first cellular communications device in a vehicle to initiate communications with a remote cellular station to request a plurality of radio resources, wherein each of the plurality of radio resources comprises a frequency sub-carrier and a timeslot;
receiving, from the remote cellular station, the plurality of radio resources;
allocating a first subset of the plurality of radio resources for use by one or more sensing applications;
allocating a second subset of the plurality of radio resources for use by one or more communications applications;
transmitting and receiving wireless signals, using the first cellular communications device and the first and second subsets of radio resources; and
processing, using a computing device coupled to the a first cellular communications device, sensor data generated based on the transmitting and receiving of the wireless signals of the first subset, wherein processing the sensor data includes determining, based on the sensor data, occupancy of the vehicle and displaying, on a display unit, the occupancy of the vehicle.

18. The computer readable medium of claim 17, wherein, in processing the sensor data, the instructions are further executable to perform one or more of the following:
classify an occupant of a given seat of the vehicle according to one or more characteristics;
determine one or more characteristics of a driver of vehicle, the one or more characteristics including one or more vital signs of the driver; and
provide identification of occupants of the vehicle.

19. The computer readable medium of claim 17, wherein the instructions are further executable to cause operation comprising:
releasing the plurality of radio resources to the remote cellular station based on movement of the vehicle;
obtaining a second plurality of radio resources from a second cellular station based on the movement of the vehicle; and
allocating first and second subsets of the second plurality of radio resources to the one or more sensing applications and the one or more communications applications, respectively.

20. The computer readable medium of claim 17, wherein the instructions are further executable to carry out operations comprising:
allocating ones of the first subset of radio resources based on respective priorities of sensing applications that use assigned ones of the first subset of radio resources, wherein a first priority level comprises safety critical sensing applications, and wherein a second, lower priority level comprises user experience-based sensing applications.
